(19) United States
(12) Patent Application Publication
(10) Pub. No.: US 2026/0281448 A1
(43) Pub. Date: Sep. 17, 2026

(54) FEATURE CHANNEL REMOVAL MECHANISM FOR FEATURE COMPRESSION BITSTREAM

(71) Applicant: InterDigital VC Holdings, Inc., Wilmington, DE (US)

(72) Inventors: Fabien Racape, San Francisco, CA (US); Hyomin Choi, Sunnyvale, CA (US); Syed Mateen Ul haq, Coquitlam (CA)

(73) Assignee: InterDigital VC Holdings, Inc., Wilmington, DE (US)

(21) Appl. No.: 19/078,903

(22) Filed: Mar. 13, 2025

(51) Int. Cl. H04N 19/70

(52) U.S. Cl. CPC H04N 19/70

(57) ABSTRACT

Systems, methods, and instrumentalities are disclosed for a device configured to receive, in a bitstream, a channel removal indication indicating whether a plurality of indices of coded channels is sorted. The device may, based on the channel removal indication indicating that the plurality of indices of coded channels is sorted, receive a coded channel count indicating a first subset of a sorted plurality of indices of coded channels to be decoded from the bitstream. The device may decode a feature tensor based on at least one coded channel indicated by the coded channel count.

### BACKGROUND

The present application is related to video coding systems that may be used to compress digital video signals, e.g., to reduce the storage and/or transmission bandwidth needed for such signals. Video coding systems may include, for example, block-based, wavelet-based, and/or object-based systems.

### BRIEF SUMMARY

Systems, methods, and instrumentalities are disclosed for a device configured to receive, in a bitstream, a channel removal indication indicating whether a plurality of indices of coded channels is sorted. The device may, based on the channel removal indication indicating that the plurality of indices of coded channels is sorted, receive a coded channel count indicating a first subset of a sorted plurality of indices of coded channels to be decoded from the bitstream. The device may decode a feature tensor based on at least one coded channel indicated by the coded channel count.

In examples, the channel removal indication may be received in a feature sequence parameter set (FSPS). The coded channel count may be received in a feature parameter picture set (FPPS) associated with the FSPS.

In examples, the device may parse a plurality of coded channels indicated by the coded channel count. A syntax element associated with the channel removal indication may be decoded is an Exp-Golomb-coded syntax element. Each channel of a second subset of the sorted plurality of indices of coded channels may be filled with an average value. The average value may be determined based on a reduced feature tensor. The channel removal indication may be bounded by a reduced feature channel count. The channel removal indication may be received as a part of feature restoration information.

In examples, the device may compute a range value indicating channel importance for each of a sorted plurality of coded channels indicated by the sorted plurality of indices of coded channels. The device may determine a threshold value based on the sorted plurality of coded channels. The device may, based on the determined threshold value, determine the first subset of the sorted plurality of coded channels.

### BRIEF DESCRIPTION OF THE DRAWINGS

The following detailed description will be better understood when read in conjunction with the appended drawings, in which there are shown examples of one or more of the multiple embodiments of the present disclosure. It should be understood, however, that the embodiments described herein are not limited to the precise arrangements and instrumentalities shown in the drawings.

FIG. 1 shows an example system according to one or more embodiments of the present disclosure.

FIG. 2 shows an example video encoder according to one or more embodiments of the present disclosure.

FIG. 3 shows an example video decoder according to one or more embodiments of the present disclosure.

FIG. 4 shows a split-inference pipeline with compression of intermediate features.

FIG. 5 shows a decomposition of a feature compression scheme.

FIG. 6 shows different channels of the reduced tensors.

FIG. 7 shows an example of a selective learning strategy.

FIG. 8 shows a decoder architecture for feature coding machine (FCM) including feature inverse transform selection.

FIG. 9 shows an example of range distribution and thresholding.

FIG. 10 shows an example channel index selection for splitting coded and removed channels.

### DETAILED DESCRIPTION

In describing the various embodiments of the present disclosure, certain terminology is used herein for convenience only and should not be considered as limiting such embodiments. In the drawings, the same reference numerals are employed for designating the same elements throughout the several figures and the present description.

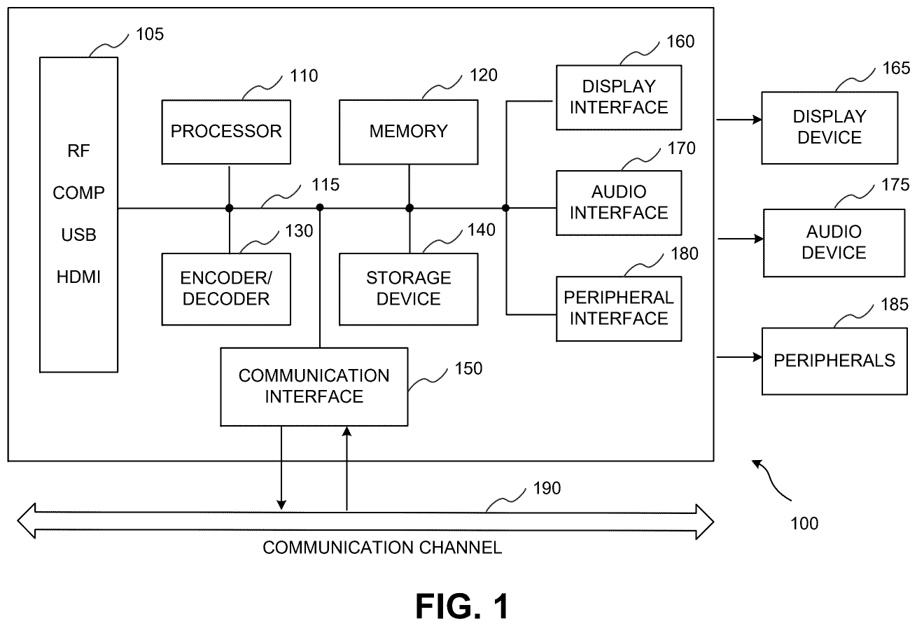

Referring to the drawings, there is shown in FIG. 1 a block diagram illustrating an example system 100 in which embodiments of the present disclosure can be implemented. The system 100 may be an electronic device including, for example, a personal computer, laptop computer, mobile phone, tablet computer, multimedia set-top box, digital television receiver, personal video recording system, connected home appliance, vehicle control and/or entertainment system, and server. One or more elements of the system 100, singly or in combination, may be implemented as an integrated circuit (IC), multiple ICs, and/or discrete components. For example, in one embodiment, the processing, encoding and/or decoding elements of system 100 are distributed across multiple ICs and/or discrete components. In some embodiments, the system 100 is communicatively coupled to and/or in communication with other systems or devices, via, for example, a communications bus or dedicated input/output ports.

One or more of the elements of system 100 may be provided within an integrated housing, with such elements being interconnected and able to transmit data therebetween using any suitable connection arrangement 115 generally known in the art, including, for example, an internal bus (e.g., 12C bus), wiring, and printed circuit boards.

The system 100 may include at least one processor 110 configured to execute instructions for implementing the embodiments described herein, including signal/data coding and processing. The processor 110 may be a general-purpose processor or microprocessor, digital signal processor (DSP), one or more microprocessors in association with a DSP core, a controller, a microcontroller, application specific integrated circuits (ASICs), field programmable gate arrays (FPGAs), a state machine, and the like. The processor 110 may include at least one central processing unit (CPU), embedded memory, input and output interfaces, and other circuitries.

The system 100 may include at least one memory 120, for example, a volatile memory device and/or a non-volatile memory device. The system 100 may include a storage device 140, that may be or include non-volatile memory and/or dynamic volatile memory, including EEPROM, ROM, PROM, RAM, DRAM, SRAM, DDR, flash, magnetic disk drives, solid state drives (SSD) and/or optical disk drives. The storage device 140 may be or include, for example, an internal storage device, an attached storage device, and/or a network accessible storage device. Although shown separately, the memory 120 and the storage device 140 may be collocated, integrated together, or otherwise combined.

The system 100 may include an encoder/decoder module 130 configured to process video data and to provide encoded video data or decoded video data. The encoder/decoder module 130 may include one or more processors and/or memory (not shown). Although FIG. 1 depicts the encoder/decoder module 130 as a separate element of system 100, it will be understood that the processor 110 and the encoder/decoder module 130 may be collocated and/or integrated together as a combination of hardware and/or software, e.g., in an electronic package or chip. The encoder/decoder module 130 may be or include one or more modules that may be included in one or more separate devices that perform encoding and/or decoding functions.

Instructions for execution by the processor 110 and/or the encoder/decoder module 130 may be stored in the storage device 140 and subsequently loaded into memory 120 for execution by the processor 110. In some embodiments, one or more of processor 110, memory 120, storage device 140, and encoder/decoder module 130 may store one or more items when performing the processes disclosed herein. Such items may include input video, decoded video or portions thereof, bitstreams, matrices, variables, operational logic, and intermediate and/or final results from processing of equations, formulas, or operations.

In some embodiments, the memory of the processor 110 and/or the encoder/decoder module 130 may be used to store instructions and/or provide working memory for video encoding and decoding functions. In some embodiments, memory external to the processor 110 and/or the encoder/decoder module 130 (e.g., the memory 120 and/or the storage device 140) may be used for one or more of these functions and/or, for example, to store the operating system of a television.

The system 100 may obtain or receive information via one or more input devices, interfaces, and/or ports as indicated in input block 105. Examples of the input devices include a radio frequency (RF) device for transmitting and/or receiving RF signals over various media, for example, RF signals received over the air from a broadcaster; component video (COMP) inputs; a Universal Serial Bus (USB) input; and/or a High-Definition Multimedia Interface (HDMI) input. Other examples include composite video input (not shown). In some embodiments, the input devices are associated with respective input processing elements, e.g., those generally known in the art. For example, the RF device may be associated with elements suitable for selecting a desired frequency (e.g., selecting or band-limiting a signal) or performing error correction on the signal. The USB and/or HDMI inputs may include respective interface processors and transceivers (or transmitters and receivers) for coupling the system 100 to other devices via USB and/or HDMI ports or connections. Various forms of input processing may be implemented, for example, by and/or within a separate input processing device or the processor 110.

The system 100 may include a communication interface 150 that enables wired and/or wireless communication with other devices, e.g., via a communication channel 190. The communication interface 150 may include one or more transceivers, modems, network cards and the like. The communication channel 190 may be or include wired and/or wireless mediums.

In some embodiments, data may be streamed to the system 100 via wired and/or wireless networks. Examples of such wireless networks include cellular, Bluetooth or Wi-Fi (e.g., IEEE 802.11) networks. The wired and/or wireless networks may include one or more base stations (e.g., cellular base stations, access points, etc.), and/or user equipment (e.g. cellular user equipment, stations, etc.), and/or other network elements that communicate with the system 100 via the communication interface 150 and communication channel 190, whereby the system 100 may obtain data streamed from streaming applications (e.g., OTT services) via various networks, including the Internet. In some embodiments, data is streamed to the system 100 via the input block 105 (e.g., using a set-top box that delivers data via the HDMI connection or the RF connection). In some embodiments, data is received by the system 100 in a non-streaming manner.

The system 100 may provide one or more output signals to one or more output devices. The output devices may include a display device 165 (e.g., touchscreen display, monitor, etc.), an audio device 175 (e.g., speakers), and other peripheral devices 185, including, for example, a stand-alone DVR, a disk player, a stereo system, a lighting system, and other devices that provide a function based on the output of the system 100. The display device 165 can be for a television, tablet, laptop, mobile phone, head-mounted display, or other device. In some embodiments, control signals are communicated between the system 100 and the display device 165, the audio device 175, and/or the peripheral devices 185, enabling device-to-device control with or without user intervention. The output devices may couple to and/or communicate with the system 100 via dedicated connections via respective display, audio, and peripheral interfaces 160, 170, 180. Alternatively, the output devices may couple to and/or communicate with the system 100 via the communication channel 190 and the communication interface 150.

The display device 165 and the audio device 175 may be collocated, integrated, or otherwise combined with the other components of system 100 in a single unit (e.g., a television). Alternatively, the display device 165 and the audio device 175 may be separate from one or more of the other components of the system 100. In embodiments in which the display device 165 and the audio device 175 are external components, the output signals may be provided via dedicated outputs and/or connections, including, for example, HDMI ports, USB ports, or COMP outputs.

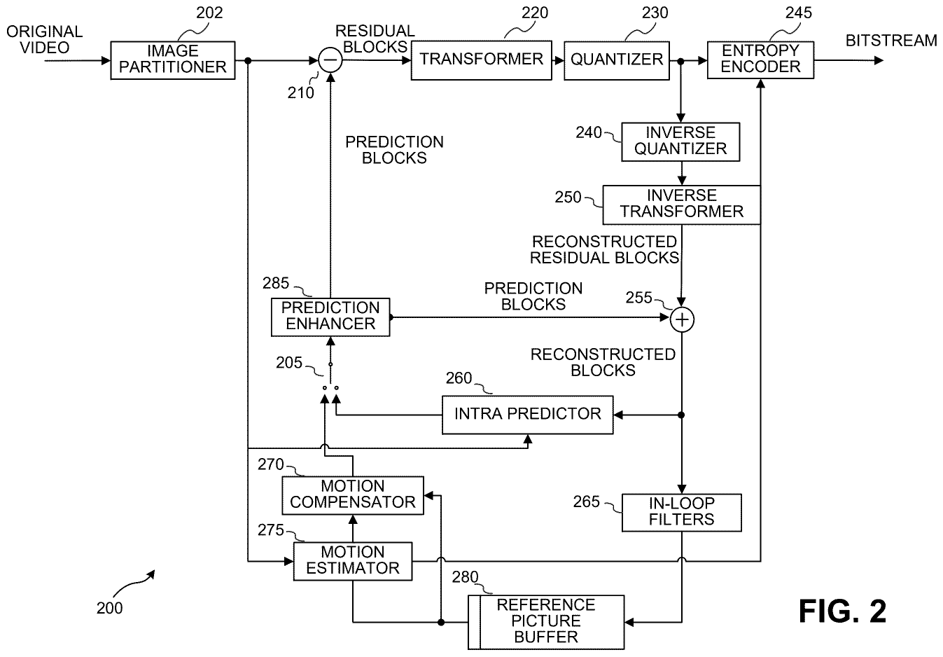

FIG. 2 is a block diagram illustrating an example video encoder 200 that may be employed by the system 100 (e.g., via the encoder/decoder module 130) described with respect to FIG. 1. The video encoder 200 may be an encoder that employs video compression technologies, standards, specification, or protocols, including Advanced Video Coding (AVC, H.264/MPEG-4), High Efficiency Video Coding (HEVC, H.265), Versatile Video Coding (VVC, H.266), Essential Video Coding (EVC, MPEG-5), AOMedia Video 1 (AV1), VP9, or the Enhanced Compression Model (ECM), and variations or improvements thereof. Those skilled in the art will understand that the various embodiments described herein are not limited to a specific standard and can be applied to other standards and recommendations, as well as extensions thereof.

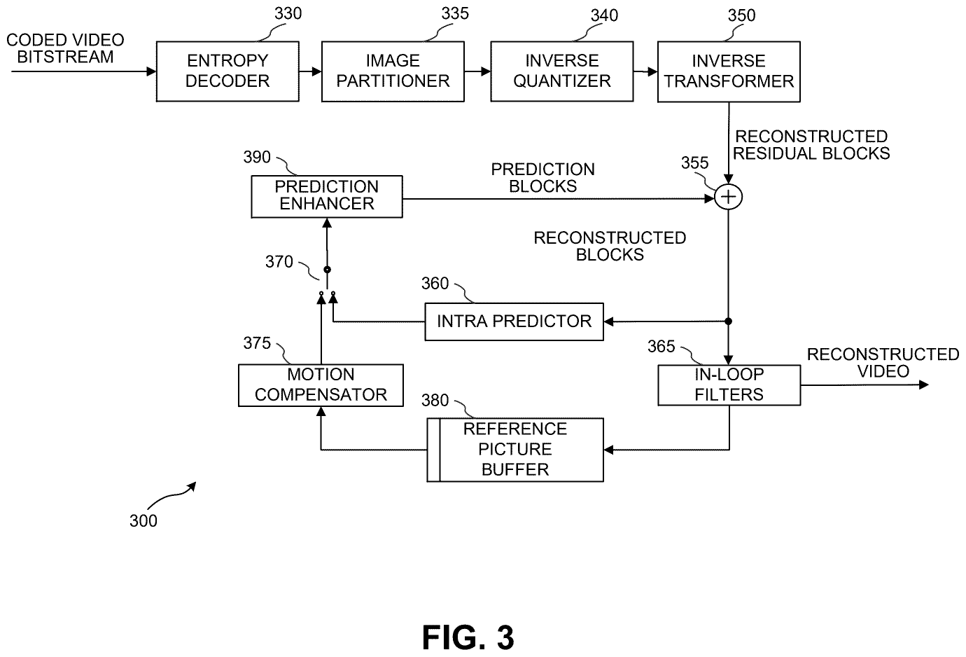

Some embodiments disclosed herein are described with reference to a coding unit (CU) or block of a video frame (or a video image or picture) to which coding tools may be applied by the video encoder 200 and/or by the video decoder 300 (described below with reference to FIG. 3). Generally, embodiments described herein may be applied to a video region formed by a video partition of any shape or size. The video region may be a video slice, a coding tree unit (CTU), or a CU (to which inter prediction or intra prediction can be applied), or a partition thereof, each of which can include samples of a luma component, Y, and chroma components, U and V (also denoted herein by C, Cb, Cr).

Referring generally to FIG. 2 and the video encoder 200, video data (e.g., one or more video frames) is encoded generally as described below. Prior to encoding, video data may be pre-processed by a precoding processor (not shown). The pre-processing may include, for example, applying a color model transform to the input color components of the input video data (e.g., conversion from RGB 4:4:4 to YUV 4:2:0) or mapping the color components of the input video data to obtain a signal distribution that is more resilient to compression (for instance, applying a histogram equalizer and/or a denoising filter to one or more of the video data's color components). The pre-processing may include associating metadata (for example, a supplemental enhancement information (SEI) message) with the video data that can be attached to a coded video bitstream. After pre-processing, if any, an image (frame) to be encoded is partitioned into CUs (blocks) by an image partitioner 202.

In general, a CU may include a luma block and associated chroma blocks. As such, functions of the video encoder 200 described herein as applied to a CU refer generally to the luma block and the respective chroma blocks. The CUs may be encoded using an intra prediction mode performed by an intra predictor 260. In intra prediction mode, the content of a CU in a frame is predicted based on content from one or more other CUs of the same frame (or region), using reconstructed blocks of other CUs output from an adder 255. The CUs may also or alternatively be encoded using an inter prediction mode, in which motion estimation and motion compensation are performed by a motion estimator 275 and a motion compensator 270, respectively. In inter prediction mode, the content of a CU in a frame is predicted based on content from one or more reconstructed areas of reference frames, available from a reference picture buffer 280.

The video encoder 200 selects or otherwise determines at 205 which prediction mode (intra prediction mode and/or inter prediction mode) to use for encoding a CU. The selected prediction mode may be enhanced (e.g., filtered) by a prediction enhancer 285. Based on the selected mode, a prediction for the CU is generated. A residual block is determined based on the prediction (e.g., prediction block, predicted CU) and the input CU. In some embodiments, such determination is made by a subtractor 210.

The residual block or a partition thereof (e.g., a transform block) is transformed into transform coefficients by a transformer 220. The transform coefficients are quantized by a quantizer 230. An entropy encoder 245 performs entropy encoding of the quantized transform coefficients and coding parameters (e.g., syntax elements including motion vectors and other control data) to form a bitstream of coded video data.

In addition to coding the original video blocks as described herein, the video encoder 200 reconstructs the coded blocks to provide references for future predictions. Thus, quantized transform coefficients (from the quantizer 230) are de-quantized by an inverse quantizer 240, and inverse transformed by an inverse transformer 250, to reconstruct (decode) the residual blocks. The reconstructed residual blocks and prediction blocks are combined (e.g., by the adder 255) to form reconstructed blocks. Thus, the video encoder 200 performs decoding operations through which the encoded images (frames) are reconstructed.

In-loop filters 265 may be applied to the reconstructed image (formed by the reconstructed blocks). The filtered reconstructed image(s) are stored in the reference picture buffer 280 and used by the motion estimator 275 and motion compensator 270, as explained above. The in-loop filters 265 can be applied to the reconstructed samples of an image to reduce distortions introduced by the encoding process. For example, a deblocking filter (DBF), bilateral filter (BIF), sample adaptive offset (SAO), and/or adaptive loop filter (ALF) can be applied to reduce encoding artifacts.

FIG. 3 is a block diagram illustrating an example of video decoder 300 that may be employed by the system 100 (e.g., via the encoder/decoder module 130) described with respect to FIG. 1. Generally, operational features of the video decoder 300 are reciprocal to operational features of the video encoder 200. In the video decoder 300, a coded video bitstream (e.g., generated by the video encoder 200 or another video encoding device or process) is entropy-decoded by an entropy decoder 330 to obtain transform coefficients, motion vectors, and other coding parameters. Based on the coding parameters, an image partitioner 335 divides the picture accordingly. The quantized transform coefficients are de-quantized by an inverse quantizer 340 and inverse transformed by an inverse transformer 350 to decode (e.g., reconstruct) respective residual blocks. Depending on the selected prediction mode, a predicted block can be obtained at 370 from an intra predictor 360 (e.g., intra prediction) or from a motion compensator 375 (e.g., inter prediction) and may be enhanced (e.g., filtered) by a prediction enhancer 390, generating a prediction block. The reconstructed residual blocks are combined with prediction blocks (e.g. by an adder 355), resulting in reconstructed blocks.

In-loop filters 365 (e.g., DBF, BIF, SAO, and/or ALF) can be applied to the reconstructed image (formed by the reconstructed blocks), to output reconstructed (decoded) video. The filtered reconstructed image is also stored in a reference picture buffer 380 for reference by the motion compensator 375.

A post-decoding processor (not shown) can process the reconstructed video data. For example, post-decoding processing can include an inverse color model transform (e.g., conversion from YUV 4:2:0 to RGB 4:4:4) or an inverse mapping to reverse the mapping process performed by the pre-encoding processor described with respect to FIG. 2. The post-decoding processor can use metadata derived by the pre-encoding processor and/or signaled in the video bitstream.

Systems, methods, and instrumentalities are disclosed for a device configured to receive, in a bitstream, a channel removal indication indicating whether a plurality of indices of coded channels is sorted. The device may, based on the channel removal indication indicating that the plurality of indices of coded channels is sorted, receive a coded channel count indicating a first subset of a sorted plurality of indices of coded channels to be decoded from the bitstream. The device may decode a feature tensor based on at least one coded channel indicated by the coded channel count.

In examples, the channel removal indication may be received in a feature sequence parameter set (FSPS). The coded channel count may be received in a feature parameter picture set (FPPS) associated with the FSPS.

In examples, the device may parse a plurality of coded channels indicated by the coded channel count. A syntax element associated with the channel removal indication may be decoded is an Exp-Golomb-coded syntax element. Each channel of a second subset of the sorted plurality of indices of coded channels may be filled with an average value. The average value may be determined based on a reduced feature tensor. The channel removal indication may be bounded by a reduced feature channel count. The channel removal indication may be received as a part of feature restoration information.

In examples, the device may compute a range value indicating channel importance for each of a sorted plurality of coded channels indicated by the sorted plurality of indices of coded channels. The device may determine a threshold value based on the sorted plurality of coded channels. The device may, based on the determined threshold value, determine the first subset of the sorted plurality of coded channels.

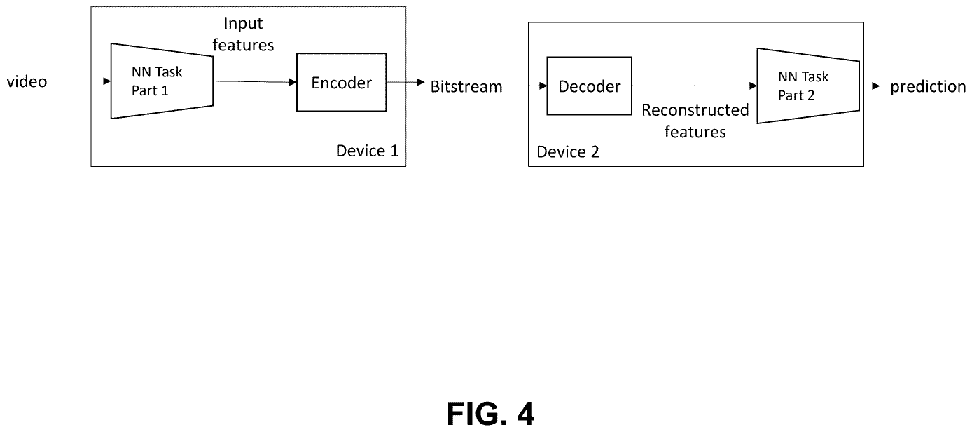

FIG. 4 illustrates a split-inference pipeline with compression of intermediate features. FIG. 4 illustrates an example of split computing in which the inference of a neural network (NN) may be shared between multiple devices (e.g., two remote devices). As shown in FIG. 4, an output of a first part (e.g., NN task part 1) of a split NN on device 1 may include features extracted by the NN (e.g., which may be referred to herein as intermediate data at a split point) and/or may be transmitted to a Device 2 (e.g., a remote Device 2). The transmission may compress (e.g., may need to compress) the intermediate data, e.g., by means of one or more features associated with video encoding (e.g., using a video encoding device and/or a video encoder). Device 2 (e.g., including a video decoding device and/or a video decoder) may receive and decode the intermediate data, for example, via a second part of the split NN (e.g., NN task part 2). In examples, device 1 may correspond to a battery-operated camera and device 2 may correspond to a remote cloud server. In examples, such splitting of the NN (e.g., a NN-based model) may be used to offload some of the computations if the device (e.g., the battery-operated camera) that captures and/or stores source contents (e.g., videos) is limited in terms of processing power, memory, and/or energy (e.g., battery power).

FIG. 4 shows a NN model split into two parts at a single split point. In examples, one or more NN models may be split several times into more than two parts across multiple devices. The proposed methods may be extended since adequate bitstreams of intermediate data may be created for each split point.

The proposed methods may apply to image and/or video content. “Video” may be an input to the neural network (NN Task Part 1). Since the method applies to intermediate data, it may apply to neural networks performed on any type of inputs in the future, for example, audio, text, medical imaging content, etc.

Different techniques may be used to compress intermediate data (e.g., data at a split point of a neural network). These techniques may include, for example, transforming the intermediate data into an array (e.g., a two-dimensional (2D) array) and applying image and/or video coding/decoding techniques (e.g., signal prediction, transforms, quantization, re-sampling, entropy coding, etc.) to the array of data, for example, to reduce the size of a bitstream.

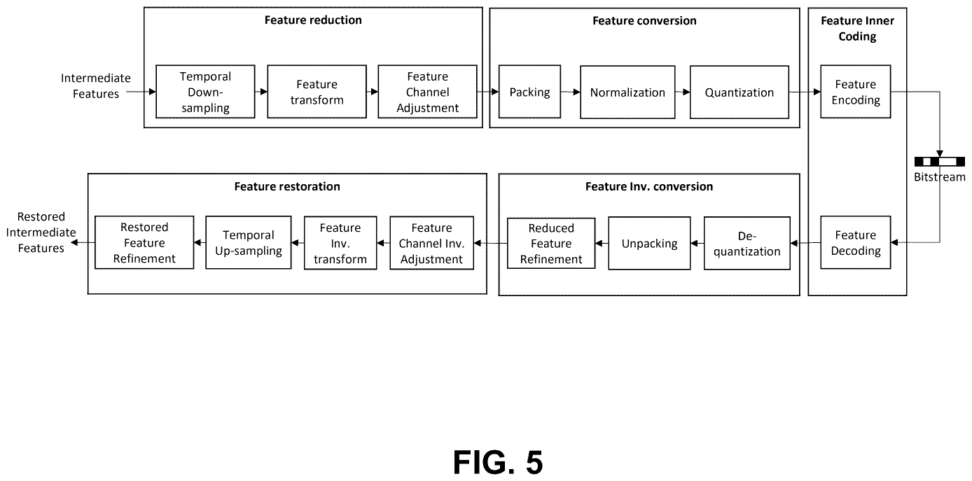

FIG. 5 shows a decomposition of a feature compression scheme. As shown in FIG. 2, an encoder may decompose the feature compression and decompression into a sequence of smaller operations (e.g., feature reduction and feature conversion).

The encoder may perform a feature reduction operation. The feature reduction operation may reduce the size of one or more large input tensors into corresponding smaller tensors. The feature reduction operation may fuse the corresponding smaller tensors into a single small tensor. In examples, for video tasks, the input feature data may take on different values over time. The feature reduction operation may create a compact tensor while keeping information (e.g., relevant information) required for accurate performance of the machine vision task.

The reduced feature tensors may undergo feature conversion. The reduce feature tensors may be packed and/or converted into an image frame that may be fed into an image or video codec, denoted as inner encoder and decoder in FIG. 5.

In examples, the tensor after the reduction process may correspond to a 3D array of dimension H×W×C, where H, W, C denote the height and width of a channel resolution and the total number of the channels, respectively. The channels can be organized as tiles of a packed frame, each channel being displayed in raster scan order for instance. The above packing operation may assume that the resulting frame is monochrome, which can for example be labeled as YUV 4:0:0 format for most existing video codecs. The other operations included in the conversion process may correspond to the normalization and quantization to properly scale and map the feature tensor values to unsigned integer values in the range of supported bit-depth by the inner codec, e.g. 8 or 10 bits.

As illustrated in FIG. 5, the feature encoding step may be encoded by an image or video encoder. The FCM bitstream may include a video bitstream and additional metadata that specify parameters and/or settings used for the intermediate data reconstruction including unpacking, rescaling to the original range of values and/or restoring the tensors to their original size and/or shape.

At the decoder, inverse operations may be performed as shown in FIG. 5. The decoder may read the bitstream and/or metadata. The decoder may feed the decoded frames to the feature conversion and restoration process. During the inverse conversion, the inverse scaling and de-packing of the tensor channels may use the provided scaling factors and geometric arrangement of the tensor channels within the packed frame. Feature restoration may take the reduced tensors and transform them back to their original shape of feature tensor or list of tensors. The feature restoration may include use of the information transmitted within the bitstream to parametrize the process for a specific split task model or specific content.

Systems and methods are provided for feature reduction process. In examples, a feature transform that relies on a trained neural network may be utilized to reduce the dimensions of the input tensors and fuse the input tensors together. In examples, a plurality of input tensors may be utilized, if a model is split at a node where the intermediate data consists of multiple tensors. In examples, a feature channel adjustment mechanism may be utilized to further reduce the transformed tensor size by discarding channels in a way that may be predicted to have minimal negative impact on the intermediate features restored by a decoder.

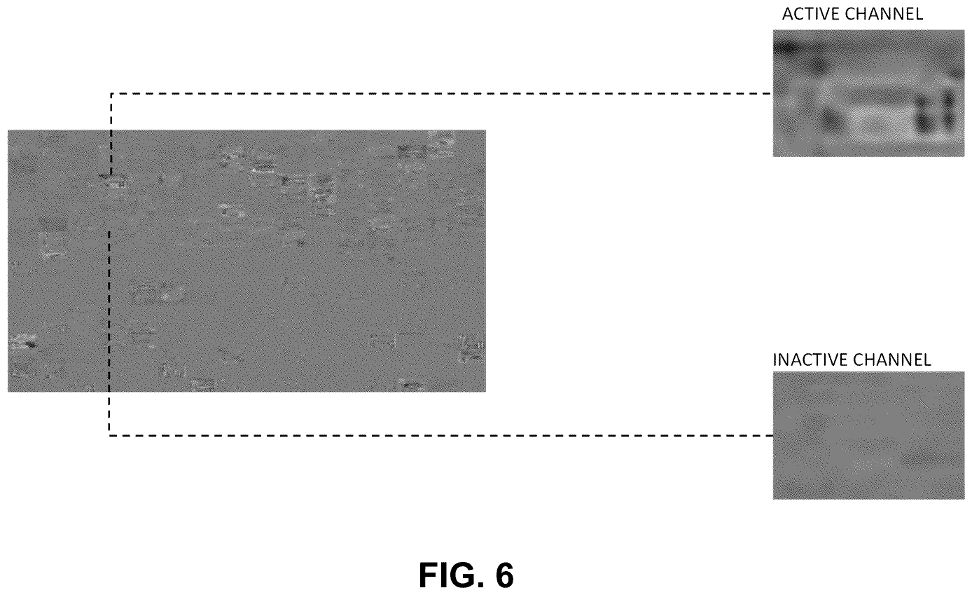

FIG. 6 illustrates different channels of the reduced tensors. The range of the values may be used within each channel to assess the impact of each channel, for example, whether a channel is considered “active” or “inactive” or may be removed. FIG. 6 illustrates different channels from the output of the feature transform. In examples, the channels may be tiled to form a 2D frame for visualization, as shown in FIG. 6. The range between the minimum and maximum values within each channel may be used to assess the impact of each channel, for example, whether it is considered “active” and/or should be transmitted or “inactive” and may be removed.

In examples, channel inverse adjustment process may be utilized to obtain reconstructed channels. The channel inverse adjustment process may involve parsing information that indicates the channels that were removed to recreate the tensor shape that the pretrained feature inverse transform expects as input. The reconstructed channels may be placed back into their spots (e.g., proper spots). Any missing channels may be filled with the average value of the decoded channels.

Syntax elements and/or methods may be provided to enable the channel inverse adjustment feature. The channel inverse adjustment feature may be enabled in different configurations of feature transform.

In examples, signaling between an encoder and a decoder may consider that the input tensor for channel removal, for example, the output of the trained feature transform is unsorted. An unsorted trained feature transform may include discarding channels associated with tensor(s) in an irregular order, for example, using a channel removal process. The transmission of a bit map, which may correspond to a list of Boolean values that indicates/identifies to a decoder the channels of the input tensor that may be decoded from the bitstream and/or the channels that may be created, for example, filled with a value that may correspond to the average value of all the decoded channels, during the feature channel inverse adjustment process. The length of this list may be equal to the number of channels of the transformed tensor by the feature transform module. The overhead of transmitted bits for this metadata may be difficult in the case of single images and/or lightweight feature bitstreams.

In examples, a training optimization framework for the feature transform and/or the inverse transform may be provided. The feature may be referred to as Selective Learning Strategy (SLS). The goal of such training strategy may be to train the feature transform to obtain a tensor with a reduced size as well as identify the channels of the tensor that may be sorted, for example, based on their importance. The training strategy may include selectively masking a subset of channels during a predefined number of iterations. In examples, the channel with index 0 may be less (e.g., the least) likely to be masked at each iteration. In examples, the higher the channel index, the more frequently the corresponding channel may be masked.

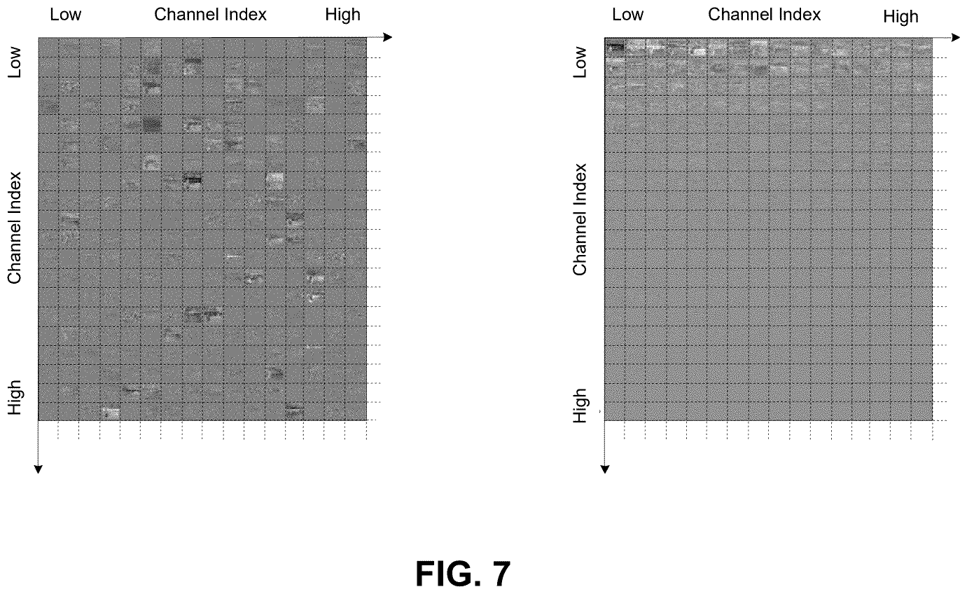

FIG. 7 illustrates a selective learning strategy (SLS) example. FIG. 7 illustrates 2D-packed channels without SLS (left) or with SLS (right). In an example, by construction, the neural network composing a feature transform may produce a tensor where the first channel may correspond to the most important channels for the feature tensor restoration and the second channel may be the second most important, and third channel may be the third most important, and so on. The left side in FIG. 7 illustrates a case where, the channels with high contrast may be randomly placed without SLS. The right of FIG. 7 illustrates, the effectiveness of the SLS approach in ordering the channels in terms of signal energy.

In examples, in MPEG FCM-based systems, various signaling mechanisms may be employed where the indices of coded channels are indicated in the bitstream.

In examples, SLS may be applied. With the SLS applied, the signaling may become simpler and more efficient since the channels are sorted in certain order from which the channel removal process may discard subsequent channels after the last channel to code.

The removal of tensor channels, for example, based on the range of their values may be combined with a training strategy that focuses on sorting the channels (e.g., based on importance).

Regardless of the SLS mechanism being utilized, in certain signaling mechanisms may use a list of Boolean values to indicate the presence of each coded channel in the bitstream. Such signaling mechanisms may be further optimized and/or simplified by, for example, sorting the channels. The channels may be sorted in certain order.

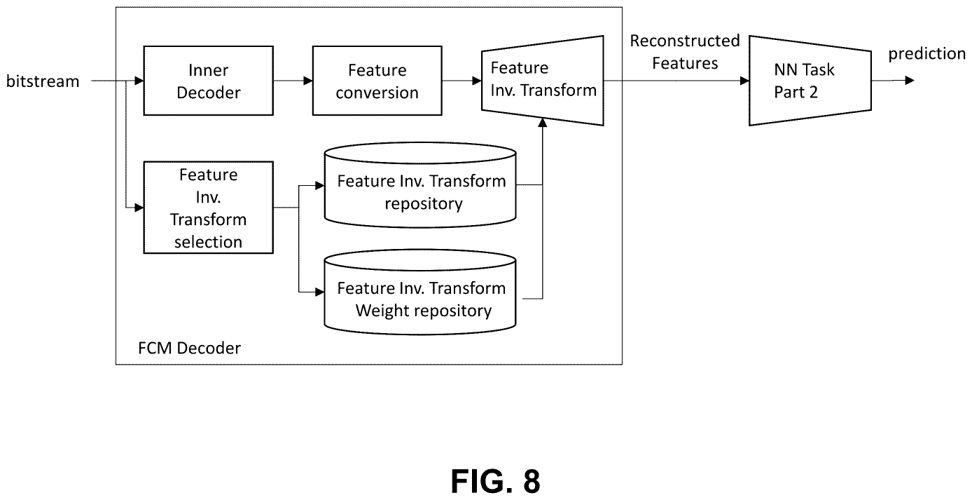

In examples, the feature transforms and/or their training may not be fixed and/or fully specified. FIG. 8 illustrates a decoder architecture for FCM including feature inverse transform selection. As illustrated in FIG. 8, a feature inverse transform model may be defined or selected from an existing repository. The feature transform at the encoder may be implemented and/or customized. Different signaling methods may be provided to indicate the coded channels (e.g., efficiently) and/or discarded channels in the bitstream for the channel adjustment stage.

Systems, methods, and/or instrumentalities may be provided where a flag may be introduced to support two different ways of signaling the list of valid channel indices to code after the feature channel adjustment process depending on whether or not the channels were sorted in a certain order (e.g., based on the channel importance). In examples, the number of coded channels may be signaled instead of a costlier binary map which indicates for each channel whether it is coded or not, for example, if the feature transform module sorts the channel using a criterion (e.g., in the order of decreasing or importance). In an example where the feature transform is disabled or does not support sorting of the channels, the binary map may be used to signal the coded and/or uncoded channels.

In an example, a flag may be signaled in a bitstream (e.g., an FCM bitstream) that indicates the signaling method that may be used to indicate the channels that are coded in the bitstream. The flag may be used to indicate signaling of the total number of coded channels or signaling coded channels using a binary map. In an example, the flag may be signaled in the Feature Sequence Parameter Set (FSPS) of the bitstream. The FSPS may include the syntax that may be valid for the whole video sequence when the input to the vision model is a video. Depending on the value of the flag, the indication of the coded channels may be transmitted in the bitstream. In an example, the indication of the coded channels may be transmitted within Feature Picture Parameter Sets (FPPS), which may be attached to one or several pictures.

Table 1 shows an FSPS that may include the channel removal indication flag, fsps_channel_removal_indication_flag.

TABLE 1

| | Descriptor |
|---|---|
| feature_seq_parameter_set_rbsp ( ) { | |
| fsps_feature_seq_parameter_set_id | |
| fsps_num_orig_feature_layers | |
| for ( i = 0; i < fsps_num_orig_feature_layers; i++ ) { | |
| fsps_orig_feature_width[ i ] | |
| fsps_orig_feature_height[ i ] | |
| fsps_orig_feature_channel_count[ i ] | |
| } | |
| fsps_reduced_feature_width | |
| fsps_reduced_feature_height | |
| fsps_reduced_feature_channel_count | |
| inner_decoder_info( ) | |
| fsps_feature_restoration_bypass_flag | |
| if( !fsps_feature_restoration_bypass_flag ) { | |
| feature_restoration_info( ) | |
| } | |
| fsps_temporal_upsampling_enable_flag | u(1) |
| fsps_restored_feature_refine_enable_flag | u(1) |
| fsps_reduced_feature_refine_enable_flag | u(1) |
| fsps_channel_removal_enable_flag | u(1) |
| if ( fsps_channel_removal_enable_flag ) { | |
| fsps_channel_removal_indication_flag | u(1) |
| } | |
| rbsp_trailing_bits( ) | |
| } | |

The channel removal indication flag (fsps_channel_removal_indication_flag) may be equal to 1 and/or specify that the total number of coded channels that may be parsed in a feature picture parameter set associated with the feature sequence parameter set in use. A binary map of size fsps_reduced_feat_channel_count may be parsed in the feature picture parameter set associated with the 5 feature sequence parameter set in use.

If fsps_channel_removal_indication_flag is true, the number of coded channels (e.g., the channels that are not removed), may be parsed from the Feature Picture Parameter Set (FPPS). The FPPSs may be valid for one or multiple video frames. This syntax may assume that the channels of the reduced feature tensors are sorted so that the first indices correspond to the more important channels. Table 2 shows a feature picture parameter set.

TABLE 2

| | Descriptor |
|---|---|
| feature_pic_parameter_set_rbsp( ) { | |
| fpps_feature_pic_parameter_set_id | |
| fpps_feature_seq_parameter_set_id | |
| if ( !fsps_dequant_bypass_flag ) { | |
| ... | |
| } | |
| if ( !fsps_unpacking_bypass_flag ) { | |
| ... | |
| } | |
| if ( fsps_restored_feature_refine_enable_flag ) { | |
| fpps_restored_feature_std | bfloat(16) |
| fpps_restored_feature_mean | bfloat(16) |
| } | |
| if ( fsps_reduced_feature_refine_enable_flag ) { | |
| fpps_reduced_feature_std | float(32) |
| fpps_reduced_feature_mean | float(32) |
| } | |
| if (fsps_feature_channel_removal_flag) { | |
| fpps_channel_removal_present_flag | u(1) |
| if ( fpps_channel_removal_present_flag ) { | |
| if ( fsps_channel_removal_indication ) | |
| fpps_coded_channel_count_minus1 | ue(v) |
| else { | |
| for ( i=0; i<fsps_reduced_feature_channel_count; i++ ) | |
| fpps_coded_channel[ i ] | u(1) |
| } | |
| } | |
| } | |
| rbsp_trailing_bits( ) | |
| } | |

The syntax element fpps_coded_channel_count_minus1+1 specifies the total number of channels that should be decoded from the bitstream. fsps_coded_channel_count_minus1 shall be in the range 0 to fsps_reduced_feature_channel_count−1.

The syntax element may be coded as ue(v) which may correspond to unsigned integer 0-th order Exp-Golomb-coded syntax element with the left bit first.

Systems, methods, and instrumentalities for feature channel restoration and decoding operations may be provided. If the channels associated with a feature tensor are sorted, for the first fpps_coded_channels_count_minus1+1 channels, the decoded channels may be copied. The remaining channels may be filled with the average value of the input RefinedReducedFeature.

An FCM feature channel adjustment process may be provided. In examples, the FCM feature channel adjustment process may be invoked if the value of fsps_channel_removal_enable_flag in the activated FSPS is equal to 1.

Input to the FCM feature channel adjustment process may be either the reduced feature ReducedFeature or the refined reduced feature RefinedReducedFeature depending on the value of fsps_reduced_feature_refine_enable_flag. Input to the FCM feature channel adjustment process may be the list fpps_coded_channel[i] with i=0 . . . fsps_reduced_feature_channel_count−1. The output of the FCM feature channel adjustment process may be a feature tensor ChannelRestoredReducedFeature.

If the value of fsps_reduced_feature_refine_enable_flag in the activated FSPS is equal to 1, the following may apply: channelRemovedReducedFeature=RefinedReducedFeature; otherwise, the following may apply: channelRemovedReducedFeature=ReducedFeature.

```
  if (fpps_channel_removal_present_flag ) {
    reduced_feature_mean = mean( RefinedReducedFeature )
    if (fsps_channel_removal_indication_flag) {
      for ( c = 0; c <= fpps_coded_channels_count_minus1; c++ ) {
        ReducedFeature[ c, :, : ] = RefinedReducedFeature[ c, :, : ]
      for ( c = fpps_coded_channels_count_minus1+1; c <
fsps_reduced_feature_channel_count; c++ ) {
        ReducedFeature[ c, :, : ] = reduced_feature_mean
    } else {
      coded_channel_idx = 0
      for ( c = 0; c < fsps_reduced_feature_channel_count; c++ ) {
        if ( fpps_coded_channel[ c ] )
          ReducedFeature[ c, :, : ] = RefinedReducedFeature[
          coded_channel_idx, :, : ]
          coded_channel_idx++
        else
          ReducedFeature[ c, :, : ] = reduced_feature_mean
      }
    }
  } else
    ReducedFeature[ :, :, : ] = RefinedReducedFeature[ :, :, : ]
```

The following notations may be used to define the access at the elements of the tensors. Tensors may be accessed to obtain specific elements or to reduce the dimensionality using the bracket ([ ]) operator. For example, a 3-dimensional tensor T, T[i, j, k] may represent an element in T that is indexed by indexes i, j, k. The colon index value (‘:’) may be used for a given dimension to return values (e.g., all values) in that dimension. For example, tensor T where T[i, j, k] is accessed as T₁=T[0, :, :] returns T₁[j, k] containing values along the dimension i=0 in the original tensor T. The colon index value may be used in conjunction with numerical values to specify a range within the considered dimension. Ranges may be specified as [a:b], such that elements from a to b−1, inclusive, are returned in the considered dimension. If a is omitted an implicit starting value if 0 is used. If b is omitted an implicit ending value of the dimension size minus 1 is used.

The algorithm described herein may be written using the following loops over the spatial elements of each channel:

```
  if (fpps_channel_removal_present_flag ) {
    reduced_feature_mean = mean( RefinedReducedFeature )
    if (fsps_channel_removal_indication_flag) {
      for ( c = 0; c <= fpps_coded_channels_count_minus1; c++ ){
          for ( j = 0; j < fsps_reduced_feature_height; j++ )
          for ( k = 0; k < fsps_reduced_feature_width; k++ )
            ReducedFeature[ c ][ j ][ k ] = RefinedReducedFeature[
            c ][ j ][ k ]
      for ( c = fpps_coded_channels_count_minus1+1; c <
fsps_reduced_feature_channel_count; c++ ) {
          for ( j = 0; j < fsps_reduced_feature_height; j++ )
          for ( k = 0; k < fsps_reduced_feature_width; k++ )
            ReducedFeature[ c ][ j ][ k ] = reduced_feature_mean
    } else {
      coded_channel_idx=0
      for ( c = 0; c < fsps_reduced_feature_channel_count; c++ ) {
        if ( fpps_coded_channel[ c ] ) {
          coded_channel_idx++
          for ( j = 0; j < fsps_reduced_feature_height; j++ )
            for ( k = 0; k < fsps_reduced_feature_width; k++ )
              ReducedFeature[ c ][ j ][ k ] = RefinedReducedFeature[
              coded_channel_idx ][ j ][ k ]
        else
        for ( j = 0; j < fsps_reduced_feature_height; j++ )
          for ( k = 0; k < fsps_reduced_feature_width; k++ )
            ReducedFeature[ c ][ j ][ k ] = reduced_feature_mean
      }
    }
  } else
    for ( j = 0; j < fsps_reduced_feature_height; j++ )
      for ( k = 0; k < fsps_reduced_feature_width; k++ )
        ReducedFeature[ c ][ j ][ k ] = RefinedReducedFeature[
        c ][ j ][ k ]
```

Various exemplary variants of the syntax elements for fpps_coded_channels_count_minus1 may be provided. In an example, a syntax element may be coded using ue(v) descriptor (e.g., unsigned integer 0-th order Exp-Golomb-coded syntax element), which may be an efficient way to encode any unbounded non-negative number. It may, however, be suboptimal when the upper bound is known.

In an example, the context of the syntax element fpps_coded_channels_count_minus1 may be bounded by fsps_reduced_feature_channel_count. In that context, the syntax element fpps_coded_channels_count may be coded using u(v). The definition of the coding for unsigned integers may be defined as follows: u(n): unsigned integer using n bits. If n is “v” in the syntax table, the number of bits may vary in a manner dependent on the value of other syntax elements. The corresponding semantics may be as follows: the syntax element fpps_coded_channel_count_minus1+1 may indicate the total number of channels that may be decoded from the bitstream. The syntax element fsps_coded_channel_count_minus1 may be in the range 0 to fsps_reduced_feature_channel_count−1. The number of bits used to represent fpps_coded_channels_count_minus1 is equal to Ceil(Log 2(fsps_reduced_feature_channel_count)).

As an example, if the feature transform model outputs a reduced tensor of 128 channels and the channel removal discards 28 channels. The unsigned integer 0-th order Exp-Golomb-coded element, fpps_coded_channels_count−1 may be coded with 6 leading zero bits, one “1”, and 6 suffix bits, hence requiring 13 bits, whereas in the mechanism described herein, it may use Ceil(Log 2(128))=7 bits.

Feature Restoration parameters in the dedicated payload may be provided. In examples, the feature restoration parameters within a feature_restoration_info( ) payload may be accessed from an associated feature sequence parameter set.

The flags related to the channel removal activation and sorting of the channels may be considered as part of the feature restoration process, for example, at the decoder. In examples, the flags may be signaled within the feature_restoration_info as shown in the table below.

Descriptor

```
feature_restoration_info( ) {
  fri_use_default_inv_transform_model_flag
  fri_channel_removal_enable_flag
  if ( fri_channel_removal_enable_flag ) {
      fri_channel_removal_indication_flag
  }
  if ( fri_use_default_inv_transform_model_flag ) {
    fri_feature_inv_transform_weight_idx
  } else {
    fcm_decoder_info_sei_id
    /* SEI::fcm_decoder_info( ) */
  }
}
```

An encoder (e.g., an FCM encoder) may be configured to provide optimized performance. If/when using the mechanism described hereinto signal the number of channels to code, it may be assumed that the encoder uses a mechanism that determines the channel index that corresponds to the last channel to code. Such a mechanism may be implemented in several different ways, for example, while conforming to the bitstream syntax described herein.

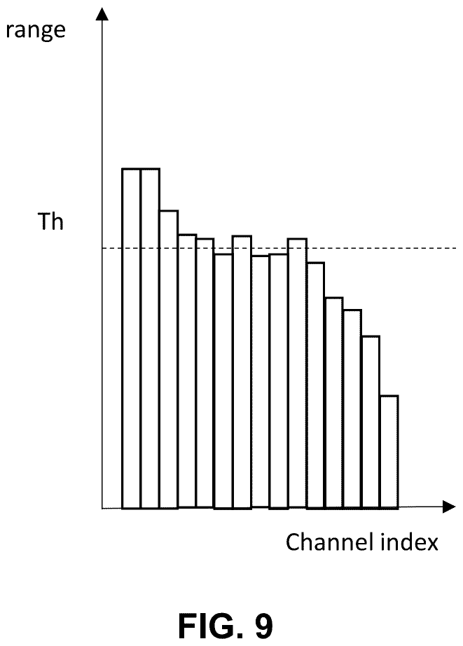

FIG. 9 shows an exemplary range distribution and thresholding. In an example, the range between the maximum and minimum values of a channel (e.g., each channel) may be deemed to indicate the channel importance with respect to the feature restoration quality for the task (e.g., final task) accuracy. For example, the individual ranges of the channels (e.g., all the channels) comprising a feature tensor may be computed (e.g., first computed) and/or compared with a threshold associated with the range. The channels (e.g., all the channels) with a smaller range value than the threshold may be removed by the feature channel adjustment process. In case where the channels have not been sorted in advance, this thresholding may lead to the removal of channels of any index. If the sorting has been performed in advance, the threshold may correspond to a channel index, which may be the boundary to segment the feature tensor into a plurality of groups (e.g., 2 groups). For example, all lower index channels with the longer range than the threshold are coded in the bitstream, and all higher index channels with the shorter range than the threshold are not coded in the bitstream. In examples, the sorting induced by the training strategy may not match the range-based criterion. For example, the selected threshold may not lead to a single index that splits the feature tensor in two segments. FIG. 9 illustrates a range distribution where a threshold “Th” may not lead to the selection of a channel index that segments the feature tensor into the group of the coded channels and the group of removed channels. Using such thresholding may include transmitting the binary map to properly indicate which channels are coded or not.

In examples, the encoder decision may be made to be more generic and/or driven by the training strategy that may sort the channels, while optimizing the signaling via the coded_channel_count_minus1 syntax element, as described herein. The decision on a channel index may be made independent of the range or other statistics of the channels. For example, depending on a target accuracy or bitrate, it may be decided to remove a given percentage of the initial number of channels. This process is similar to defining a rank when performing linear reduction such as low-rank decomposition or principal component analysis (PCA) method.

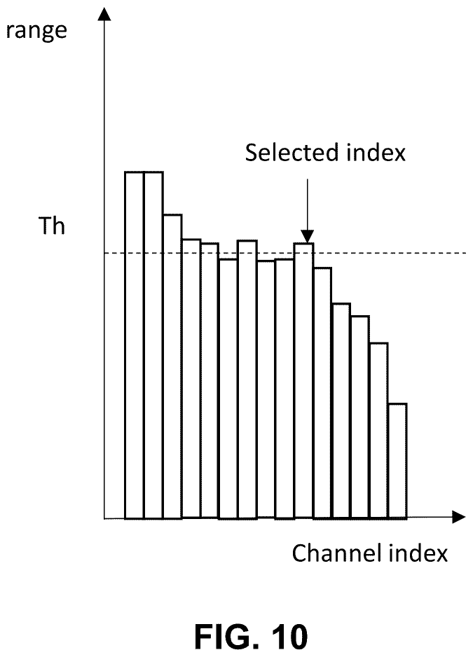

FIG. 10 shows an example channel index selection for splitting coded and removed channels. In an example, the encoder decision may be made relative to statistical metrics such as standard deviation. As shown in FIG. 10, the selection of the “split channel index” may be made on the highest index for the last coded channel that satisfies the threshold associated with the corresponding statistical metric.

In examples, the number of removed channels may be signaled instead of the number of coded channels. The syntax and decoded operations described herein may be modified such that the channel removal indication may correspond to the removed channels.

In examples, the channel indication may correspond to a list of Boolean values. In such a case, the size of the overhead in terms of transmitted bits for this information may not change, and he coded values may be “1” if the channel is removed and “0”, if the channel is not removed.

In examples, the indication may represent the number of removed channels. In such a case, the overhead may vary, depending on how many channels are removed vs. coded. Since the coding methods described herein use less bits for smaller numbers, coding the number of removed channels may lead to a lower overhead, for example, if the number of removed channels is smaller than the number of coded channels.

The syntax may be modified as follows:

| | Descriptor |
|---|---|
| feature_pic_parameter_set_rbsp( ) { | |
| fpps_feature_pic_parameter_set_id | |
| fpps_feature_seq_parameter_set_id | |
| if ( !fsps_dequant_bypass_flag ) { | |
| ... | |
| } | |
| if ( !fsps_unpacking_bypass_flag ) { | |
| ... | |
| } | |
| if ( fsps_restored_feature_refine_enable_flag ) { | |
| fpps_restored_feature_std | bfloat(16) |
| fpps_restored_feature_mean | bfloat(16) |
| } | |
| if ( fsps_reduced_feature_refine_enable_flag ) { | |
| fpps_reduced_feature_std | float(32) |
| fpps_reduced_feature_mean | float(32) |
| } | |
| if (fsps_feature_channel_removal_flag) { | |
| fpps_channel_removal_present_flag | u(1) |
| if ( fpps_channel_removal_present_flag ) { | |
| if ( fsps_channel_removal_indication ) | |
| fpps_removed_channel_count_minus1 | ue(v) |
| else { | |
| for ( i=0; i<fsps_reduced_feature_channel_count; i++ ) | |
| fpps_removed_channel[ i ] | u(1) |
| } | |
| } | |
| } | |
| rbsp_trailing_bits( ) | |
| } | |

In an example, the following decoding process may be provided. This subclause may be invoked if the value of fsps_channel_removal_enable_flag in the activated FSPS is equal to 1. An input to this process may be either the reduced feature ReducedFeature or the refined reduced feature RefinedReducedFeature depending on the value of fsps_reduced_feature_refine_enable_flag. An input to this process may be the list fpps_coded_channel[i] with i=0 . . . fsps_reduced_feature_channel_count−1.

An output of this process may be a feature tensor ChannelRestoredReducedFeature. If/when the value of fsps_reduced_feature_refine_enable_flag in the activated FSPS is equal to 1, the following may apply:
channelRemovedReducedFeature=RefinedReducedFeature

The following may apply (e.g., if not channelRemovedReducedFeature=RefinedReducedFeature), channelRemovedReducedFeature=ReducedFeature

```
  if (fpps_channel_removal_present_flag ) {
    reduced_feature_mean = mean( RefinedReducedFeature )
    if (fsps_channel_removal_indication_flag) {
      for ( c = 0; c <= fsps_reduced_feature_channel_count −
fpps_removed_channels_count_minus1 −1; c++ ) {
      ReducedFeature[ c, :, : ] = RefinedReducedFeature[ c, :, : ]
      for ( c = <= fsps_reduced_feature_channel_count −
      fpps_removed_channels_count_minus1; c
< fsps_reduced_feature_channel_count; c++ ) {
        ReducedFeature[ c, :, : ] = reduced_feature_mean
    } else {
      coded_channel_idx = 0
      for ( c = 0; c < fsps_reduced_feature_channel_count; c++ ) {
        if ( !fpps_removed_channel[ c ] ) {
          ReducedFeature[ c, :, : ] = RefinedReducedFeature[
          coded_channel_idx, :, : ]
          coded_channel_idx = 0
        } else
          ReducedFeature[ c, :, : ] = reduced_feature_mean
      }
    }
  } else
    ReducedFeature[ :, :, : ] = RefinedReducedFeature[ :, :, : ]
```

One or more embodiments provide a computer program comprising instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various methods and aspects described herein can be used to modify one or more modules. For example, the intra predictors and inter predictors described with respect to FIGS. 2 and 3 may be implemented as one or more modules and modified according to the various embodiments of the present disclosure.

The various embodiments described herein provide at least the following features, devices or aspects, alone or on any combination, across various claim categories and types:
i. Encoding, into coded video data, syntax elements that can enable the decoder to decode the coded video data, according to any of the embodiments described herein.
ii. Video data (e.g., a bitstream) that may include one or more of the described syntax elements, or variations thereof, whether transmitted, stored, or otherwise made available.
iii. Creating, transmitting, receiving, and/or decoding of the bitstream.
iv. An electronic device (e.g., TV, set-top box, mobile phone, tablet, etc.) that tunes a channel to receive a bitstream or that receives such bitstream over the air. The electronic device decodes the syntax elements from the bitstream, and, optionally, displays (e.g., via a monitor or other type of display) a resulting image.

Various numeric values are used in the present application. Such specific values are for example purposes and the embodiments described are not limited to these specific values.

Various methods are described herein, and such methods comprise one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present disclosure may refer to “determining” various pieces of information. Determining information may include one or more of, for example, estimating, calculating, predicting, or retrieving (e.g., from memory) the information.

The present disclosure may refer to “accessing” various pieces of information. Accessing information may include one or more of, for example, receiving, retrieving (e.g., from memory), storing, moving, copying, calculating, determining, predicting, or estimating the information. Similarly, the present disclosure may refer to “receiving” various pieces of information. Receiving information may include one or more of, for example, accessing or retrieving (e.g., from memory) the information.

“Decoding,” as used herein, encompasses all or part of the processes performed, for example, on an encoded sequence to produce an output suitable for display. In some embodiments, such processes include one or more of the processes typically performed by a decoder, for example, entropy decoding, inverse quantization, etc. Whether the phrase “decoding process” is intended to refer to a subset of operations or generally to the broader decoding process will be clear based on the context of the specific description and will be well understood by those skilled in the art.

“Encoding,” as used herein, encompasses all or part of the processes performed, for example, on input video data an order to produce an encoded bitstream. Additionally, the terms “reconstructed” and “decoded” may be used interchangeably, the terms “encoded” or “coded” may be used interchangeably, the terms “image,” “picture,” “sub-picture,” “slice,” and “frame” may be used interchangeably, and the terms “pixel” and “sample” may be used interchangeably.

The present disclosure refers to information, for example, syntax elements, that can be transmitted or stored. Such information can be packaged or arranged in a variety of manners, including for example manners common in video standards such as putting the information into a sequence parameter set (SPS), a picture parameter set (PPS), a network abstraction layer (NAL) unit, a header (for example, a NAL unit header, or a slice header), or an SEI message. Other manners are also available, including, for example, manners that are common for system level or application-level standards such as signaling the information into one or more of the following:
i. session description protocol (SDP), for example as described in RFCs and/or used in conjunction with real-time transport protocol (RTP) transmission.
ii. hypertext transfer protocol (HTTP) live Streaming (HLS) manifest transmitted over HTTP.
iii. dynamic adaptive streaming over HTTP (DASH) media presentation description (MPD) descriptors, for example as used in DASH and transmitted over HTTP.
iv. RTP header extensions, for example as used during RTP streaming.
v. International Organization for Standardization (ISO) base media file format, for example, as used in Omnidirectional MediA Format (OMAF).

As used herein, “signal” and “signaling” refer to, among other things, indicating information to a decoder. For example, in some embodiments the encoder signals a quantization matrix for de-quantization, whereby the same parameter may be used for both encoding and decoding. In some embodiments, the signaling may be explicit, such that information (e.g., a particular parameter) is transmitted to the decoder enabling the decoder to use the same particular parameter. In some embodiments, the signaling may be implicit, in that the information (e.g., a particular parameter) is indicated based on other information at or transmitted to the decoder or derived or selected by the decoder based on information available at the decoder. By not transmitting the information (e.g., the particular parameter), bit savings is thus realized in some embodiments. In some embodiments, one or more syntax elements or flags are used to signal information to a decoder. While the preceding relates to the verb form of the word “signal”, the word “signal” can also be used herein as a noun.

In some embodiments, signals may be produced that are formatted to carry information that may be stored or transmitted. Such information may include, for example, instructions for performing a method, or data produced by one of the described implementations (e.g., a bitstream of a described embodiment). Such a signal may be formatted, for example, as an electromagnetic wave or as a baseband signal. The formatting may include, for example, encoding a data stream and modulating a carrier with the encoded data stream. The information that the signal carries may be, for example, analog or digital information. The signal may be transmitted over a variety of different wired or wireless links and may be stored on a processor-readable medium.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present disclosure or the following claims. Although features and elements are described herein in particular combinations, those of ordinary skill in the art will appreciate that such features or elements may be used alone or in any combination with the other features and elements. It is understood, therefore, that the overall teachings of the present disclosure are not limited to the particular embodiments, implementations, and examples disclosed herein, but are intended to cover variations, modifications, and alternatives as defined by the appended claims and any and all equivalents thereof.

What is claimed is:

1. A decoding device comprising:
a processor configured to:
receive, in a bitstream, a channel removal indication indicating whether a plurality of indices of coded channels is sorted;
based on the channel removal indication indicating that the plurality of indices of coded channels is sorted, receive a coded channel count indicating a first subset of a sorted plurality of indices of coded channels to be decoded from the bitstream; and
decode a feature tensor based on at least one coded channel indicated by the coded channel count.

2. The decoding device of claim 1, wherein the channel removal indication is received in a feature sequence parameter set (FSPS).

3. The decoding device of claim 2, wherein the coded channel count is received in a feature parameter picture set (FPPS) associated with the FSPS.

4. The decoding device of claim 3, wherein the processor is further configured to parse a plurality of coded channels indicated by the coded channel count.

5. The decoding device of claim 1, wherein a syntax element associated with the channel removal indication is to be decoded is an Exp-Golomb-coded syntax element.

6. The decoding device of claim 1, wherein each channel of a second subset of the sorted plurality of indices of coded channels is filled with an average value that is determined based on a reduced feature tensor.

7. The decoding device of claim 6, wherein the channel removal indication is bounded by a reduced feature channel count.

8. The decoding device of claim 1, wherein the channel removal indication is received as a part of feature restoration information.

9. A decoding method comprising:
receiving, in a bitstream, a channel removal indication indicating whether a plurality of indices of coded channels is sorted;
based on the channel removal indication indicating that the plurality of indices of coded channels is sorted, receiving an indication of a first subset of a sorted plurality of indices of coded channels to be decoded from the bitstream; and
decoding a feature tensor based on at least one coded channel indicated by the first subset of the sorted plurality of indices of coded channels.

10. The decoding method of claim 9, wherein the channel removal indication is received in a feature sequence parameter set (FSPS).

11. The decoding method of claim 10, wherein the coded channel count is received in a feature parameter picture set (FPPS) associated with the FSPS.

12. The decoding method of claim 11, wherein the method further comprises parsing a plurality of coded channels indicated by the sorted plurality of indices of coded channels.

13. The decoding method of claim 9, wherein a syntax element associated with the channel removal indication is to be decoded is an Exp-Golomb-coded syntax element.

14. The decoding method of claim 9, wherein each channel of a second subset of the sorted plurality of indices of coded channels is filled with an average value that is determined based on a reduced feature tensor.

15. The decoding method of claim 14, wherein the channel removal indication is bounded by a reduced feature channel count.

16. The decoding method of claim 9, wherein the channel removal indication is received as a part of feature restoration information.

17. An encoding device comprising:
a processor configured to:
send, in a bitstream, a channel removal indication indicating whether a plurality of indices of coded channels is sorted;
based on the channel removal indication indicating that the plurality of indices of coded channels is sorted, send a coded channel count indicating a first subset of a sorted plurality of indices of coded channels to be decoded from the bitstream; and
encode a feature tensor based on at least one coded channel indicated by the coded channel count.

18. The encoding device of claim 17, wherein the channel removal indication is sent in a feature sequence parameter set (FSPS).

19. The encoding device of claim 18, wherein the coded channel count Is is sent in a feature parameter picture set (FPPS) associated with the FSPS.

20. The encoding device of claim 17, wherein the processor is configured to:
compute a range value indicating channel importance for each of a sorted plurality of coded channels indicated by the sorted plurality of indices of coded channels;
determine a threshold value based on the sorted plurality of coded channels; and
based on the determined threshold value, determine the first subset of the sorted plurality of coded channels.
